(19) United States
(12) Patent Application Publication
(10) Pub. No.: US 2010/0200784 A1
(43) Pub. Date: Aug. 12, 2010

(54) Bellowphragm actuated fluid control swing valve

(76) Inventor: Charles James Turner, Lakeside, CA (US)

Correspondence Address: Larry E Severin, Esq, 3581 Teaberry Circle, Seal Beach, CA, 90740, US

(21) Appl. No.: 12/541,844

(22) Filed: Aug. 14, 2009

Related U.S. Application Data
(60) Provisional application No. 61/152,048, filed on Feb. 12, 2009.

(51) Int. Cl. F16K 31/126

(52) U.S. Cl. 251/61.1; 137/484.6

(57) ABSTRACT

A bellowphragm actuated fluid control swing valve includes: a fluid-tight body having an inlet for the fluid, a seat around the inlet, an outlet for the fluid, and a hinge, the body conducting the fluid from the inlet to the outlet; a fluid-tight chamber adapted to be pressurized with the fluid, the chamber generally enclosed by the body; a first surface of the chamber, foldably pleated so as to extend in response to the chamber being pressurized; second surface of the chamber, rotatably attached to the hinge, so that, when the first surface extends, the second surface rotates about the hinge; a disc on the second surface of the chamber that mates with the seat; and a generally non-folding cover attached to the first surface of the chamber so that the cover and first surface cooperate to form the chamber and make the chamber fluid-tight.

This application claims the benefit of the filing date of U.S. Patent Application No. 61/152,048, filed Feb. 12, 2009.

### BACKGROUND OF THE INVENTION

The present invention generally relates to valves and more specifically to a bellowphragm actuated fluid control swing valve.

Some valves cannot completely overcome cavitations problems and cannot open fully to nominal pipe size.

It would be desirable to have a valve that controls pressure, flow, reverse flow, or a combination of these conditions.

### SUMMARY OF THE INVENTION

In one aspect of the present invention, a valve for controlling flow of a fluid includes: a fluid-tight body having an inlet for the fluid, a seat around the inlet, an outlet for the fluid, and a hinge, the body conducting the fluid from the inlet to the outlet; a fluid-tight chamber adapted to be pressurized with the fluid, the chamber generally enclosed by the body; a first surface of the chamber, foldably pleated so as to extend in response to the chamber being pressurized; second surface of the chamber, rotatably attached to the hinge, so that, when the first surface extends, the second surface rotates about the hinge; a disc on the second surface of the chamber that mates with the seat; and a generally non-folding cover attached to the first surface of the chamber so that the cover and first surface cooperate to form the chamber and make the chamber fluid-tight; wherein, when the chamber is pressurized, the first surface extends, the second surface rotates about the hinge, and the disc mates with the seat, thereby controlling the flow of the fluid from the inlet to the outlet.

In another aspect of the present invention, a valve for controlling flow of a fluid includes: a fluid-tight body having an inlet for the fluid, a seat around the inlet, an outlet for the fluid, and a hinge, the body conducting the fluid from the inlet to the outlet; a fluid-tight chamber adapted to be pressurized with the fluid, the chamber generally enclosed by the body; a first surface of the chamber, foldably pleated so as to extend in response to the chamber being pressurized; a second surface of the chamber, rotatably attached to the hinge, so that, when the first surface extends, the second surface rotates about the hinge; a disc on the second surface of the chamber that mates with the seat; and a generally non-folding cover attached to the first surface of the chamber so that the cover and first surface cooperate to form the chamber and make the chamber fluid-tight; wherein, when the chamber is pressurized, the first surface extends, the second surface rotates about the hinge, and the disc mates with the seat, thereby controlling the flow of the fluid from the inlet to the outlet.

In yet another aspect of the present invention, a method for controlling flow of a fluid includes: providing a fluid-tight chamber having a first surface that is foldably pleated and a second surface having a disc; inletting the fluid into an inlet, conducting the fluid to an outlet, and outletting the fluid; pressurizing the fluid-tight chamber with the fluid; extending the first surface in response to the chamber being pressurized; and rotating the second surface so that the disc mates with a seat, thereby forming a seal, and controlling flow of the fluid.

### BRIEF DESCRIPTION OF THE DRAWINGS

FIG. 1 depicts an embodiment of the invention in the closed position;

FIG. 2 depicts an embodiment of the invention with the cover vented to atmosphere;

FIG. 3 depicts an embodiment of the invention with inlet pressure connected to the valve cover;

FIG. 4 depicts an embodiment of the invention with a three-way valve; and

FIG. 5 depicts an embodiment of the invention in the open position, with a restrictive value and a modulating control valve.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the invention is a pneumatically or hydraulically operated, bellowphragm-actuated fluid control swing valve. A “bellowphragm” is like a bellows for a diaphragm. It has pleated sides that fold and straighten like bellows, to allow an airtight or fluid-tight cover chamber to contract and expand under pressure. When pressurized, the chamber expands to push a disc against a seat, sealing the valve shut. The disc could be a resilient disk, O-ring, or other gasket-like, flexible or locally-deformable surface that mates with the seat to make a tight fit.

Embodiments of the invention could help prevent damage to piping systems, prevent cross contamination of water systems, and regulate flow and pressure to provide safe, working plumbing systems. Embodiments could be used in a piping system to control fluids, including liquids or gases. Embodiments can be made to accommodate any pipe size or system.

Embodiments of the present invention 10 may include the following: a hinge 12; a cover 14; a body 16; a bellowphragm assembly 18; a resilient disc 20; a seat 22; an inlet 24; and an outlet 26. Embodiments may include an on/off control 28; a restrictive valve 30; and a modulating valve 32. Embodiments may include attachment mechanisms for cover 14 and bellowphragm 18 to form a chamber, and a pilot or other fluid-supplied valve on the chamber.

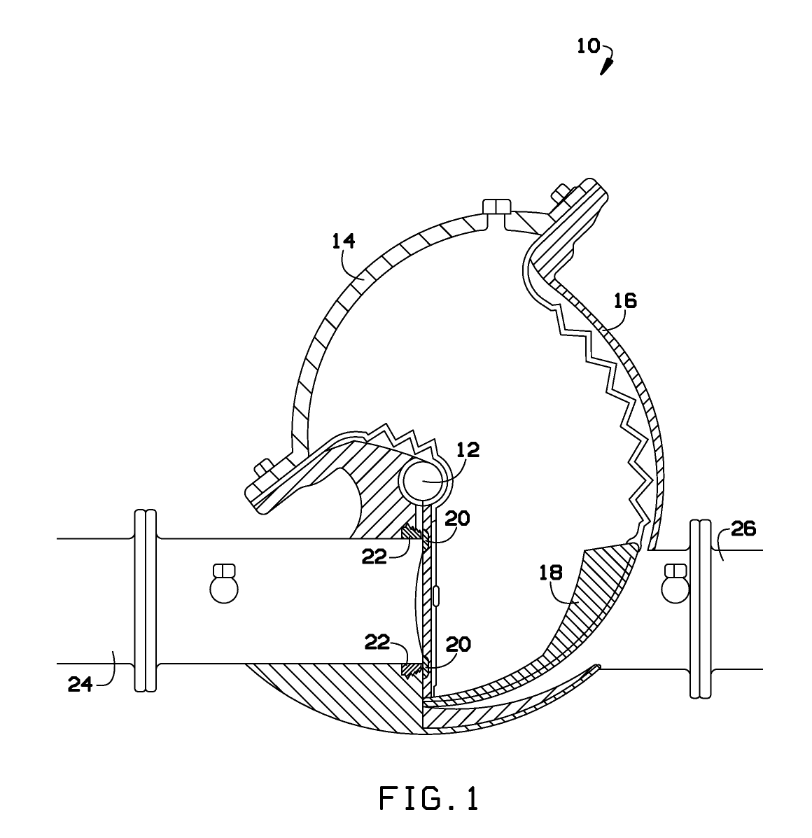

As depicted in the embodiment of FIG. 1, a valve 10 includes a valve body 16, a cover 14, a bellowphragm type assembly 18, a valve seat 22, and a resilient disc 20 on the bellowphragm type assembly 18. The cover 14 and bellowphragm 18 are attached to each other with bolts, adhesives, or other attachment mechanisms, to form an airtight chamber with bellows at the sides, so that the chamber can expand and contract. The bellowphragm assembly 18 and the resilient disc 20 are generally enclosed by the combination of the body 16 and the cover 14. With no pressure in the valve, only the weight of the bellowphragm assembly resists the force of liquid entering inlet 24, to hold or partially hold the valve closed. When there is pressure in the chamber, the bellowphragm 18 expands, with the bellows-like sides straightening out. This causes a torque around the hinge 12, so that resilient disc 20 is pressed against seat 22, holding the valve shut. When the chamber is depressurized, so that the pressure in the bellowphragm chamber is low relative to the inlet 24, the bellowphragm 18 rotates or swings around hinge 12, and the valve opens. By controlling the amount of pressure in the bellophragm chamber, the valve can be held in any position to act as a throttle between fluids flowing from inlet 24 to outlet 26.

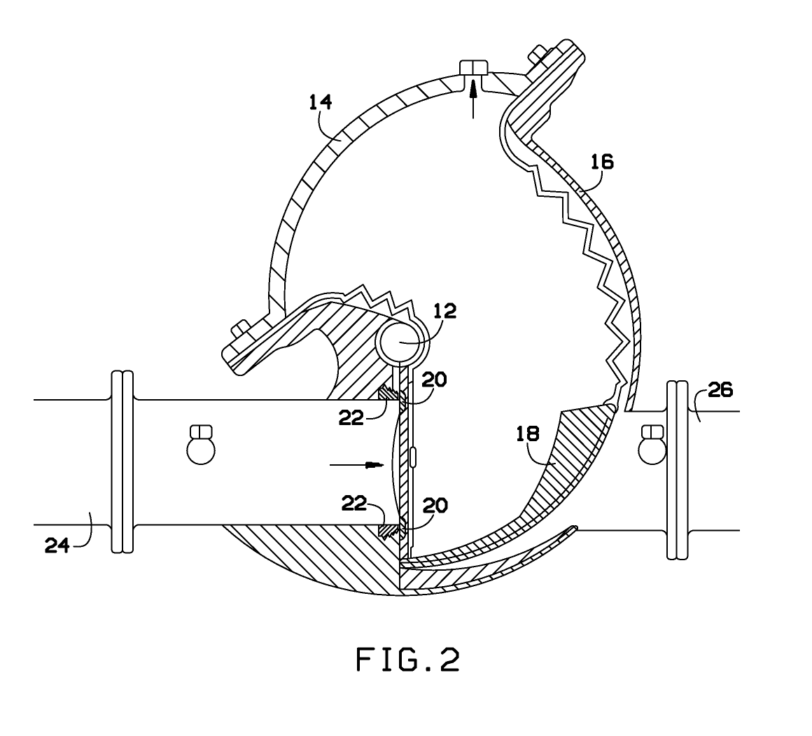

As depicted in FIG. 2, with the cover chamber vented to the atmosphere or downstream, the valve will open from line pressure pushing against the disc on the bellowphragm assembly. If inlet 24 pressure is connected to the cover chamber, the valve closes tightly.

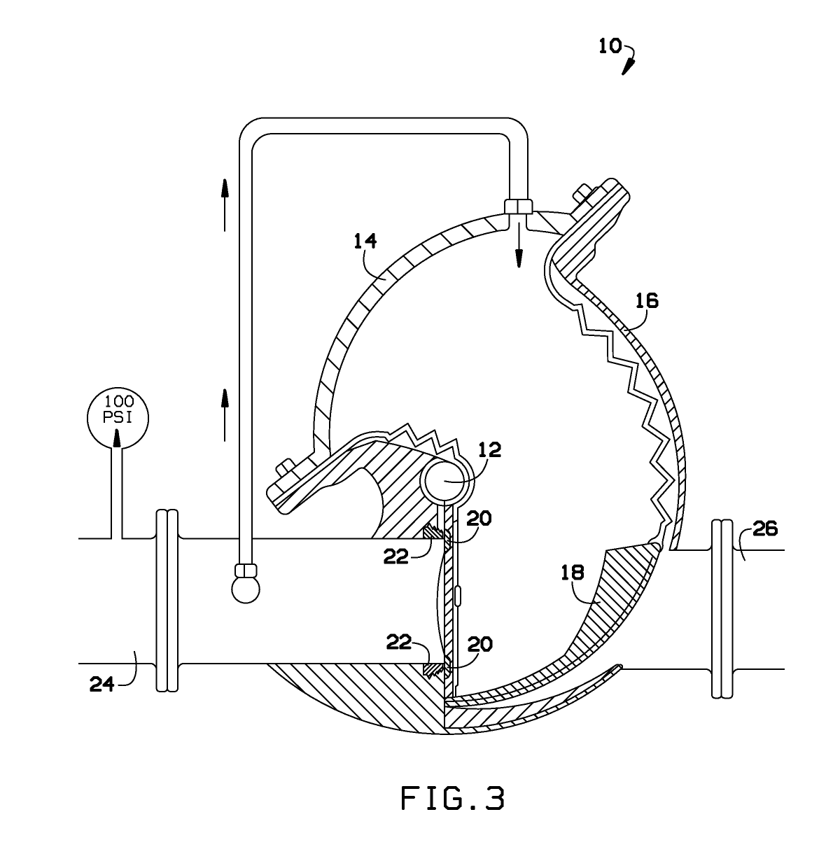

As depicted in FIG. 3, an embodiment of the invention has 100 pounds per square inch (PSI) inlet 24 pressure connected to the cover. In an embodiment, the area of the seat 22, which is on the side near inlet 24, is 6 square inches. The area behind the disc 20, nearer to outlet 26, is 10 square inches, which is larger than the seat diameter. The closing force in this example would be 100 PSI×10 square inches=1000 lbs, and the opening force is 100 PSI*6 square inches=600 lbs, so that a 400 pound difference pushes the disc against the seat, causing the valve to seal drip-tight.

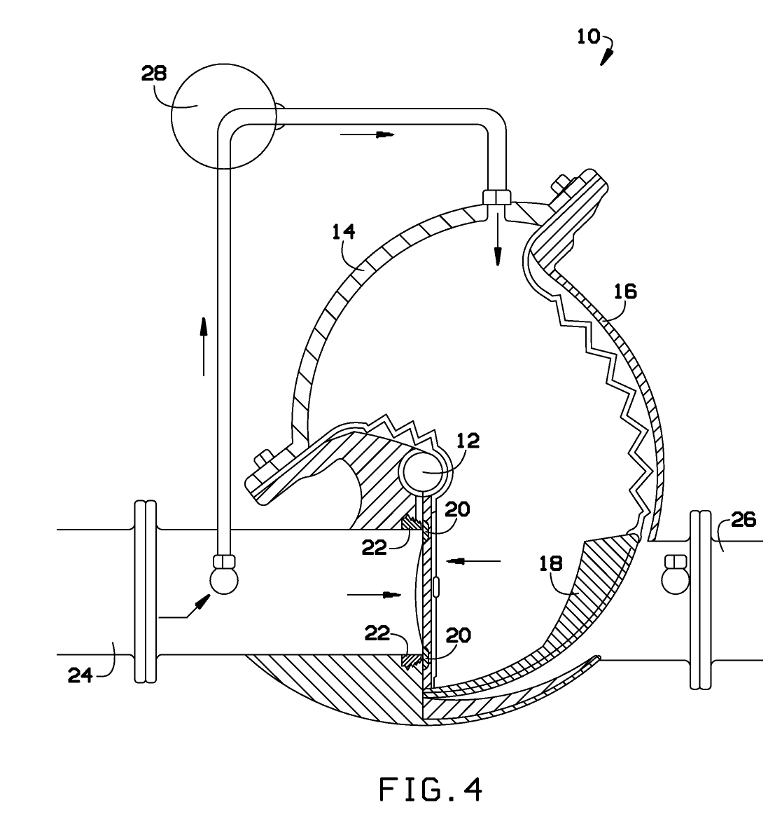

As depicted in FIG. 4, an embodiment includes a simple control 28 that either opens the valve full open or closes it tightly. This is called a three-way valve.

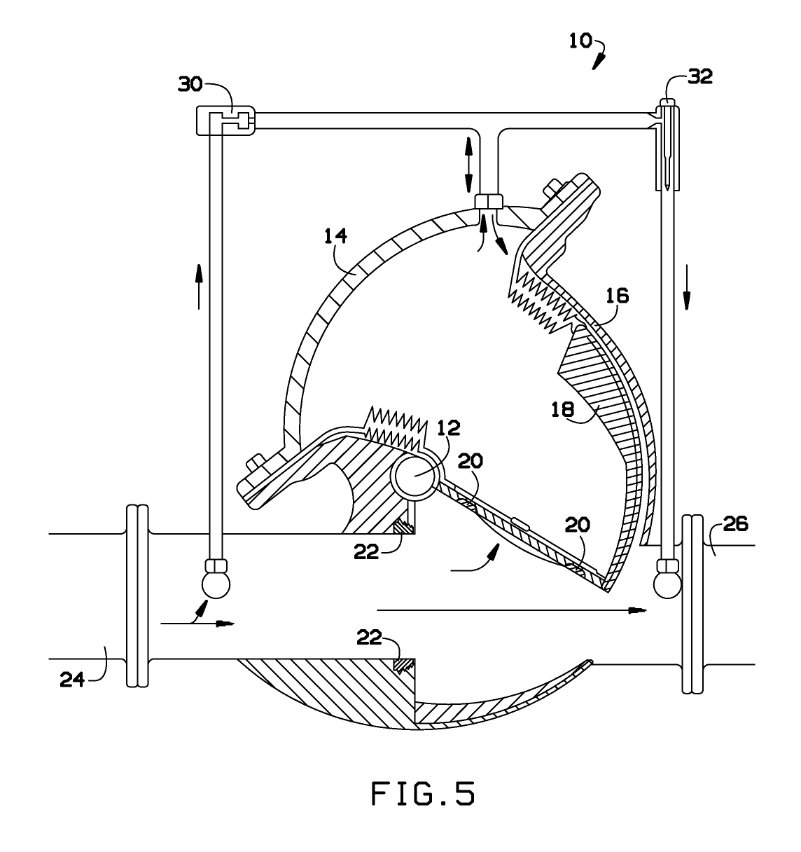

As depicted in FIG. 5, another embodiment includes a modulating control 32 can be added to keep the valve throttling in any position.

In the embodiment of FIG. 5, the bellowphragm 18 is contracted, causing the resilient disc 20 to rotate about hinge 12, thereby opening the value. Fluid entering inlet 24 is allowed to flow through to outlet 26.

In another embodiment (not shown), a one-way valve could be made by adding a tube from the down-stream side of the valve, near the outlet 26, to the cover chamber.

In other embodiments, several automatic pilot control valves could be incorporated on the main valve. Valves can be made to any size piping system. In other embodiments, fluids other than water can be used to provide pressure to the chamber.

I claim:

1. A valve for controlling flow of a fluid, comprising:
a body having an inlet for the fluid, a seat around the inlet, an outlet for the fluid, and a hinge;
a fluid-tight chamber adapted to be pressurized with the fluid;
a first surface of the chamber, foldably pleated so as to extend in response to the chamber being pressurized;
a second surface of the chamber, rotatably attached to the hinge and the first surface, so that, when the first surface extends, the second surface rotates about the hinge; and
a disc on the second surface of the chamber that mates with the seat;
wherein, when the chamber is pressurized, the first surface extends, the second surface rotates about the hinge, and the disc mates with the seat, thereby controlling the flow of the fluid from the inlet to the outlet.

2. The valve of claim 1, wherein the body is fluid-tight, the body generally encloses the fluid-tight chamber, and the body conducts the fluid from the inlet to the outlet.

3. The valve of claim 1, further comprising:
a generally non-folding cover attached to the first surface of the chamber so that the cover and first surface cooperate to form the chamber and make the chamber fluid-tight.

4. The valve of claim 1, further comprising:
a conduit conducting the fluid to a valve on the chamber to pressurize the chamber with the fluid.

5. The valve of claim 1, wherein the disc is a resilient disc and the seat is shaped so as to mate with the resilient disc so as to make a fluid-tight seal, thereby closing the valve.

6. The valve of claim 1, further comprising:
a third surface of the chamber that is foldably pleated so as to extend and cooperate with the first surface, to allow the chamber to expand, and to allow the second surface to rotate about the hinge as the chamber expands.

7. The valve of claim 1, wherein the second surface is larger than the seat, the second surface pressing the disc against the seat so that the disc and seat make a fluid-tight seal, thereby closing the valve.

8. The valve of claim 1, wherein the chamber is adapted to be partly pressurized so that the disc does not fully seal with the seat, and the chamber partially impedes the flow of the fluid from the inlet to the outlet.

9. A valve for controlling flow of a fluid, comprising:
a fluid-tight body having an inlet for the fluid, a seat around the inlet, an outlet for the fluid, and a hinge, the body conducting the fluid from the inlet to the outlet;
a fluid-tight chamber adapted to be pressurized with the fluid, the chamber generally enclosed by the body;
a first surface of the chamber, foldably pleated so as to extend in response to the chamber being pressurized;
a second surface of the chamber, rotatably attached to the hinge, so that, when the first surface extends, the second surface rotates about the hinge;
a disc on the second surface of the chamber that mates with the seat; and
a generally non-folding cover attached to the first surface of the chamber so that the cover and first surface cooperate to form the chamber and make the chamber fluid-tight;
wherein, when the chamber is pressurized, the first surface extends, the second surface rotates about the hinge, and the disc mates with the seat, thereby controlling the flow of the fluid from the inlet to the outlet.

10. The valve of claim 9, further comprising:
a cover on the chamber to pressurize the chamber utilizing.

11. The valve of claim 9, further comprising:
a third surface of the chamber that is foldably pleated so as to extend and cooperate with the first surface, to allow the chamber to expand, and to allow the second surface to rotate about the hinge as the chamber expands.

12. The valve of claim 9, wherein the disc is a resilient disc and the second surface is larger than the seat, the second surface pressing the disc against the seat so that the disc and seat make a fluid-tight seal, thereby closing the valve.

13. A method for controlling flow of a fluid, comprising:
providing a fluid-tight chamber having a first surface that is foldably pleated and a second surface having a disc;
inletting the fluid into an inlet, conducting the fluid to an outlet, and outletting the fluid;
pressurizing the fluid-tight chamber with the fluid;
extending the first surface in response to the chamber being pressurized; and
rotating the second surface so that the disc mates with a seat, thereby forming a seal, and controlling flow of the fluid.

14. The method of claim 13 further comprising:
providing a fluid-tight body that generally encloses the fluid-tight chamber and that conducts the fluid from an inlet to the outlet.

15. The method of claim 13 further comprising:
conducting the fluid to a valve on the chamber; and
pressurizing the chamber with the fluid.

16. The method of claim 13 further comprising:
providing a third surface of the chamber that is foldably pleated;
extending the third surface so as to extend and cooperate with the first surface to allow the chamber to expand; and
rotating the second surface as the chamber expands.

17. The method of claim 13 further comprising:
partly pressurizing the chamber so that the disc does not fully seal with the seat; and
partially impeding the flow of the fluid from the inlet to the outlet.
